(19) United States
(12) Patent Application Publication
(10) Pub. No.: US 2007/0291916 A1
(43) Pub. Date: Dec. 20, 2007

(54) TELEPHONE INTERCOM REMOTE LINE INTERFACE MODULES FOR INSTALLATIONS WITH NON-LOCALIZED POINTS OF DEMARCATION

(76) Inventor: David L. Oblad, San Bernardino, CA (US)

Correspondence Address: KLEIN, O'NEILL & SINGH, LLP, 43 CORPORATE PARK, SUITE 204, IRVINE, CA, 92606, US

(21) Appl. No.: 11/763,351

(22) Filed: Jun. 14, 2007

Related U.S. Application Data
(60) Provisional application No. 60/804,809, filed on Jun. 14, 2006.

(51) Int. Cl. H04M 1/00

(52) U.S. Cl. 379/159

(57) ABSTRACT

An intercom system for use with a remote demarcation point includes a remote demarcation interface module operatively connected to the remote demarcation point, wherein the remote demarcation interface module selectively connects and disconnects with the remote demarcation point. In the system, a control module connects a subscriber telephone instrument to a remote demarcation point. The control module includes a processor module that includes processor logic operative to receive and process one or more signals, and subscriber monitor logic operative to monitor the subscriber telephone instrument activity and to provide a subscriber control signal to the processor logic. A steering relay module is operative to selectively connect and disconnect the subscriber telephone instrument to the remote demarcation point upon receipt of a steering control signal from the processor logic, wherein the steering control signal is generated by the processor module based upon the subscriber control signal.

### CROSS-REFERENCE TO RELATED APPLICATIONS

This application claims the benefit, under 35 U.S.C. Section 119(e), of co-pending Provisional Application No. 60/804,809, filed Jun. 14, 2006, the disclosure of which is incorporated by reference herein in its entirety.

### FEDERALLY-SPONSORED RESEARCH OR DEVELOPMENT

Not Applicable

### REFERENCE TO APPENDIX

Not Applicable

### BACKGROUND

This invention relates to telephone intercom systems for multiple resident buildings, and in particular, to intercom systems with non-localized points of demarcation with either single stations (concierge) or multiple stations (concierge, door attendant, valet, management office, etc.)

Conventional telephone sets, i.e., those coupling to the “tip and ring” terminals of a conventional analog “local loop” of a “Plain Old Telephone Service” (“POTS”) or a PBX, typically comprise a “transmitter” (e.g., a mouthpiece or microphone), a “receiver” (e.g., a speaker or earphone), and a manually actuated “switchhook” mechanism that switches the set between an “off-hook” condition, i.e., one coupled to the local loop for signaling and communication purposes, and an “on-hook” condition, i.e., one decoupled from the local loop. The analog current-signaling technique employed in such telephones enables them to operate without need for an external power supply, since all of the electrical power needed to operate the set, 48 VDC at up to 120 mA, or 5-6 W, is supplied on the local loop by the local telephone company (“Telco”) or PBX so long as the telephone set is in the off-hook condition. However, when the set is in the on-hook condition, i.e., decoupled from the local loop, the maximum amount of power that the set can draw from the local loop is substantially limited, by FCC regulation, to 480 μW, i.e., 48 VDC at 10 μA.

Telephone intercom systems facilitate internal building communication between a remote participant (or “subscriber” or “resident”) and another location (or “station”), such as a concierge, door attendant, valet, management office, and the like, without incurring charges from the telephone company. Currently there are two main types of telephone intercom systems. The first type is a “call up” telephone intercom system where the subscriber uses a telephone to provide visitors entry into the building without having to walk to the entrance and open the door. The second type is the “call up and call down” system where the subscriber not only uses a telephone to provide visitors entry into the building, but can also use the telephone to call down to another station to initiate an intercom telephone call with a limited number of door attendant/concierge/valet/management office telephones.

Conventional telephone intercom systems are designed to interface with the building telephone system at the telephone company's (or “Telco”) single point of demarcation. The telephone company routes all incoming resident Telco lines to a central location, such as a telephone room, which is designated as the point of demarcation for the telephone company. Telephone intercom systems, which are considered building capital equipment, interface with the incoming resident Telco lines after the point of demarcation to allow internal building communication from the entry door telephone or concierge telephone to the subscriber telephone (call up) and subscriber telephone to the concierge telephone (call down). The telephone company's responsibility for telephone service ends at the point of demarcation.

Current trends in construction of new multiple resident buildings include “fiber to residence,” i.e. new points of demarcation are now extended to each floor and/or all the way to each individual apartment or condominium. As a result, the telephone company is no longer bringing all of the Telco lines into the building to a single point of demarcation, but instead routing the lines to multiple remote demarcation points. Conventional telephone entry systems are unable to work in the “fiber to residence” building designs without running multiple sets of twisted pairs from the residence to the telephone room, and do not provide an interface with the Telco/resident telephone line non-localized points of demarcation.

As the telephone intercom system can no longer complete its interface in the local telephone room, a need exists for a system that provides an intercom control unit in a centralized location that can interface with the resident's telephone through a remote demarcation interface module connected to the intercom control unit by a single twisted two wire pair.

### SUMMARY OF THE INVENTION

As used herein, the terms “the invention” and “the present invention” shall encompass the specific embodiments disclosed herein, as well as any and all equivalents that may suggest themselves to those skilled in the pertinent arts.

In one aspect, the present invention is an intercom system for use with a remote demarcation point. The intercom system includes a remote demarcation interface module. The remote demarcation interface module is operatively connected to the remote demarcation point wherein the remote demarcation interface module selectively connects and disconnects with the remote demarcation point.

In a second aspect, the present invention is a control module to connect a subscriber telephone instrument to a remote demarcation point. The control module includes a processor module to receive and process one or more signals, a subscriber monitor logic to monitor the subscriber telephone instrument activity and provide a subscriber control signal to the processor logic. The control module further includes a steering relay module to selectively connect and disconnect the subscriber telephone instrument to the remote demarcation point upon receipt of a steering control signal from the processor logic. The steering control signal is generated by the processor module based upon the subscriber control signal.

In a third aspect, the present invention is a method to connect a subscriber telephone instrument to a remote demarcation point and an intercom control unit. The method includes the steps of monitoring the subscriber telephone instrument activity and providing a subscriber control signal to a processor logic; and generating a steering control signal based upon the subscriber control signal to selectively connect and disconnect the subscriber telephone instrument to the remote demarcation point and the intercom control unit.

A better understanding of the above and many other features and advantages of the invention may be obtained from a consideration of the detailed description of the invention below, especially if such consideration is made in conjunction with the appended drawing.

### BRIEF DESCRIPTION OF THE DRAWINGS

FIG. 1 is a block diagram of a telephone intercom system in accordance with a preferred embodiment of the present invention;

FIG. 2 is a block diagram of a remote demarcation interface module in accordance with a preferred embodiment of the present invention; and

FIG. 3 is a schematic diagram of the remote demarcation interface module of FIG. 2.

### DETAILED DESCRIPTION OF THE INVENTION

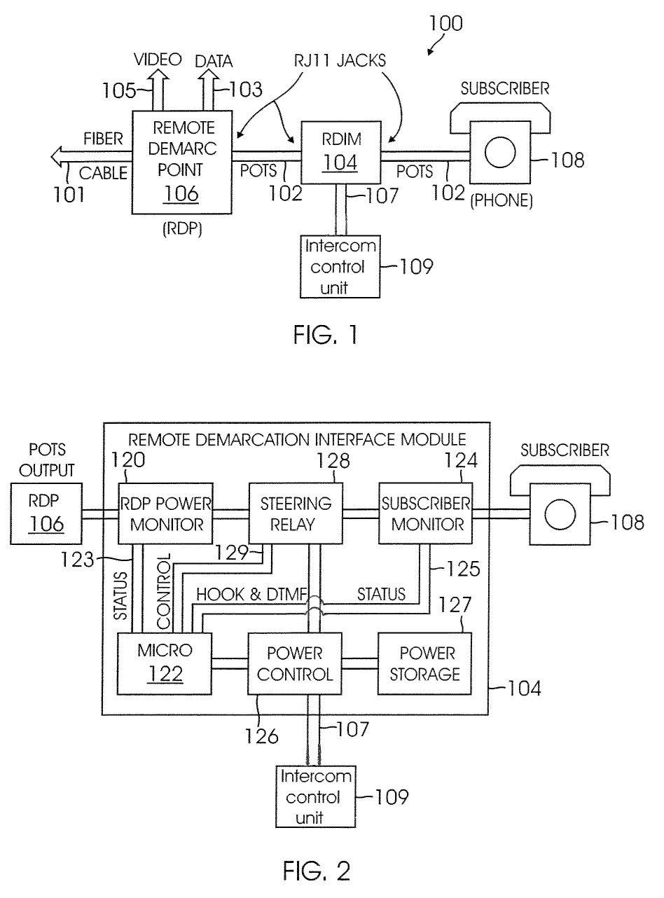

A block diagram of a telephone intercom system 100 in accordance with a preferred embodiment of the present invention is illustrated in FIG. 1. The system 100 can be applied to both “call up” systems and “call up and call down” systems.

Cable and fiber technology 101 is being increasingly used to provide data 103, video 105 and voice services to subscribers. By using cable and fiber technology, the point of telephone service demarcation is no longer located in one central location and remote points of demarcation are now located on each floor and/or in each individual apartment or condominium. Since there is no longer one central location for demarcation, a remote demarcation point 106 is needed for each subscriber. If remote demarcation points are located on each floor, cable must be supplied to each apartment or condominium on each floor to the remote demarcation point from a remote demarcation interface module (“RDIM”) 104 provided for each subscriber.

As conventional telephone intercom systems are designed to interface centrally with the telco/resident telephone lines at a single telephone company point of demarcation, an intercom control unit 109 is necessary in a centralized location to supervise all the remote non-localized demarcation points 106. The intercom control unit 109 processes all calls between the subscriber and remote stations and interfaces with each subscriber's telephone through a remote demarcation interface module 104. In the preferred embodiment of the present invention, the intercom control unit 109 is a Model 6000R manufactured by Trigon Electronics, Inc., of Corona, Calif. All telco/resident phone lines are connected to the intercom control unit 109 via a remote demarcation interface module 104. The intercom control unit 109 processes the calls between the entrance to the building and the subscriber. The telephone company is not involved, so the subscriber does not incur any charges.

A single two-wire twisted pair 107 connects the intercom control unit 109 to the remote demarcation module 104 on a per subscriber basis, and it is used to transmit data to the intercom control unit 109. The wire pair 107 is a mirror image of the subscriber lines, such that when the subscriber goes off hook, the remote demarcation module 104 reflects this condition to the intercom control unit 109 by also going off hook (creates loop-start current path).

Remote demarcation interface modules 104 can be installed at any point phone line service ends in a “Plain Old Telephone Service” (“POTS”) 102 type service jack, such as a conventional RJ11 2-wire female phone jack. When installing a remote demarcation interface module 104, a POTS Tip/Ring signal is first passed through the remote demarcation interface module 104 and then transmitted to subscriber phones 108. This allows the remote demarcation module 104 to act as a splitter providing dual service (telco and intercom) to one subscriber and preventing a clash of controls, signals and power, which would normally occur when the intercom control unit 109 and the telco service both control the subscriber's phone.

The intercom control unit 109 passively monitors the subscriber's phone, i.e. without the telco service, and supplies power to the phone for dialing purposes by supplying power to the remote demarcation interface module 104 so that it is in a stand-by-mode. If the remote demarcation interface module 104 determines that there is no telco power, the remote demarcation module 104 supplies power to the subscriber's phone and disconnects the telco service at the remote demarcation module 104. If the telco service returns, the remote demarcation interface module 104 restores the telco power to the subscriber phone and resumes passive monitoring.

During passive monitoring, if the subscriber goes off hook and draws operational loop start current, then the remote demarcation interface module 104 disconnects the telco service. If the subscriber dials a number, the dialing tones are transferred to the intercom control unit 109 as if it has a real connection to the subscriber phone. Thus, the remote demarcation interface module 104 generates a mirror image of the subscriber phone to the intercom control unit 109 which is interpreted as the real subscriber's phone. If a call is placed to the subscriber, via the intercom control unit 109, that call returns a busy signal to the intercom user, such as the Concierge, if the subscriber's line is currently in use on a regular telco call. If the subscriber is not using the phone, the ring signal to the remote demarcation interface module 104 temporarily disconnects the telco service and allows the intercom ring signal to reach the subscriber phone directly. After the call is answered by the subscriber and completed when the subscriber hangs up, the remote demarcation interface module 104 resumes passive monitoring of the subscriber's phone and service.

The subscriber's phone service does not detect the remote demarcation module 104, as the impedance or capacitance is not impacted. However, due to the added load, the available voltage will drop by approximately one volt and will appear as an additional parallel resistance of more than 5.1 Megohms. This voltage drop has no effect on the system 100 as the telco supplies 48V to the system 100, and a typical phone only needs 7-10V. Telco lines are current-regulated to provide only the needed power; otherwise all the extra voltage will be wasted in the form of heat.

To utilize the telephone intercom system 100 of the present invention, a subscriber presses a key or a series of keys on a telephone, creating a Dual Tone Multi-Frequency (“DTMF”) signal. A copy of the DTMF signal is transmitted to the intercom control unit 109 on the wire pair 107, providing the intercom control unit 109 with the status of the subscriber (i.e. whether or not the subscriber is on the telephone) on a per-subscriber basis.

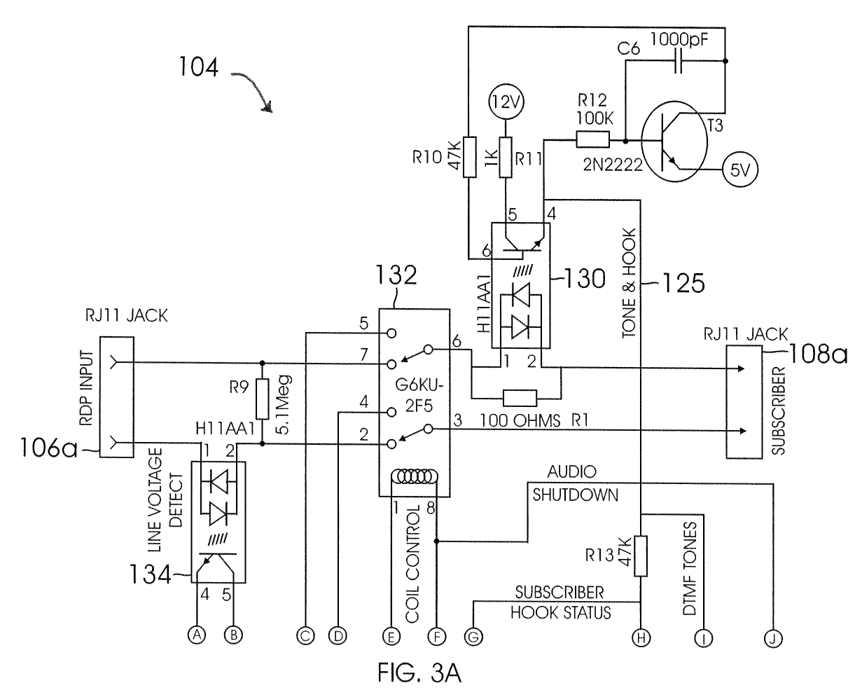

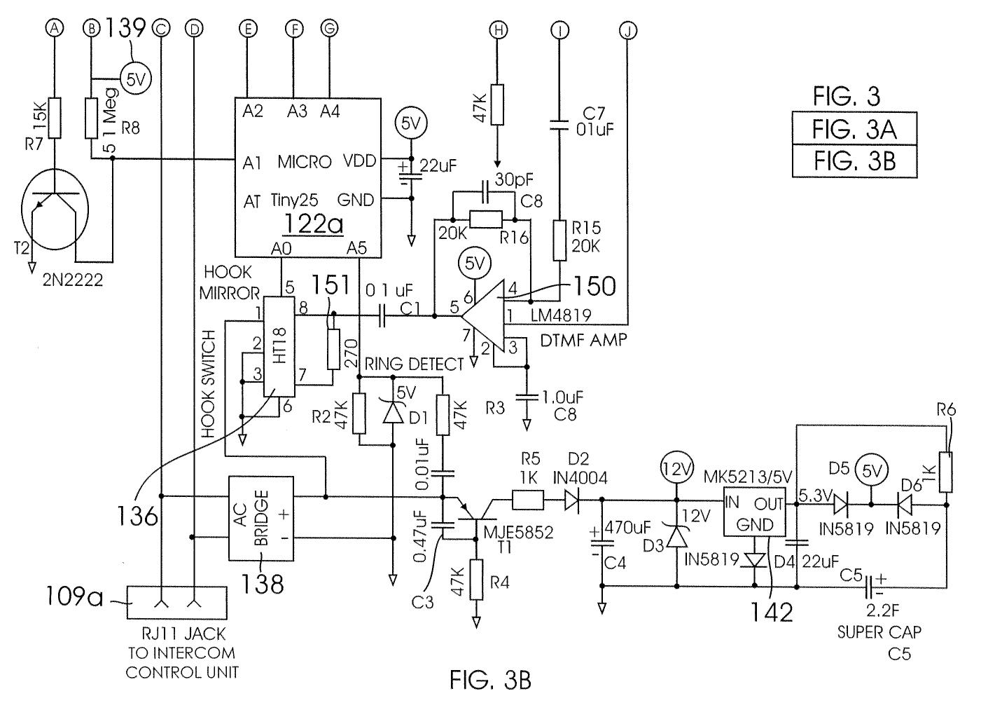

Turning to FIG. 2, a block diagram of the internal structure of the remote demarcation interface module 104 of FIG. 1 is shown. The remote demarcation interface module 104 connects a subscriber to a remote demarcation point 106. A remote demarcation point (RDP) power monitor 120, connected to the remote demarcation point 106, monitors the output voltage of the remote demarcation point 106 via a 5.1 Megohm resistor R9 (FIG. 3). This output voltage is then transmitted to a microprocessor module 122, via a status line 123, providing the micro-processor module 122 with the status of the subscriber, i.e. if the subscriber is on the telephone.

A subscriber monitor 124, connected to the subscriber phones 108, monitors the subscriber hook loop current status, DTMF dialing and ring signal. The hook loop current status indicates if the subscriber is on the telephone. Lifting a phone off the cradle closes the hook switch, thus completing the loop for power to flow using the phone as the power load. If there is a flow of current, the phone is in use. If there is not a flow of current, the phone is not in use.

A first small opto-coupler 130 (FIG. 3), such as a H11AA1, within the subscriber monitor 124 reads the subscriber hook loop current status, DTMF dialing, and ring signal, and it transmits this data to the microprocessor module 122 for analysis via a status line 125. With this information, the microprocessor module 122 determines if the subscriber is on the phone, and thus enables the mirror of the subscriber actions to the intercom control unit 109 via the wire pair 107. The mirror functions require more power than just passive monitoring. This additional power is supplied by a 2.2 F “super cap” C5 (FIG. 3) in a power storage cell 127 that has been trickle-charged (as described below) from the intercom Loop-Start voltage.

A power control block 126 is connected to the microprocessor module 122 and trickle charges a power storage cell 127 in the remote demarcation interface module 104 using the 24V Loop-Start voltage. The 24V Loop-Start Voltage is power made available for the subscriber's phone to enable the phone to operate, such as the generation of dial tones and the generation of DTMF signals for dialing. In the case of a remote demarcation interface module 104, the 24V Loop-Start Voltage supplies power to operate a microprocessor 122a (see FIG. 3) in the microprocessor module 122, and to trickle charge the power cell 127. The loading must be kept very low, so as not to be mistaken for all off-look loop-start power draw greater than 15 mA. The power control block 126 receives a mirror image of the data on the subscriber lines, such that when the subscriber goes off hook (i.e. the subscriber is on the telephone), the microprocessor 122a instructs the power supplied from the intercom control unit 109 to be likewise loaded.

A steering relay 128, such as a G6KU-2F5 DPDT relay, is connected between the RDP power monitor 120 and the subscriber monitor 124. The steering relay 128 is controlled by the microprocessor module 122 through a control line 129. If the microprocessor module 122 determines that the remote demarcation point 106 is powered down, out of service or simply doesn't exist, the steering relay 128 switches the subscriber directly to the intercom control unit 109, via the power control block 126. The intercom control unit 109 communicates with the subscriber directly and provides the service voltage (i.e., the voltage required to power the phone after a call has been started, that is, after dialing has begun) to the subscriber phone 108, so that the subscriber can dial a number via DTMF. The DTMF number dialed by the subscriber is received by the intercom control unit 109, either as a mirror of the actual status of the subscriber or directly.

Specific number sequences are preprogrammed into the system for the subscriber to use. If the subscriber dials a specific pre-defined number sequence, such as 48# which indicates a call back request, the intercom control unit 109 registers this as a call back request, and the request is put into a queue for processing. For example, a subscriber may request that the manager of the units call back the subscriber when the subscriber is off the telephone. Once the micro-processor module 122 of RDIM of the subscriber detects that the subscriber is no longer on the telephone, which status is also visible to the intercom control unit 109 and the microprocessor module of RDIM of the manager telephone is also free (i.e. Off Hook), the intercom control unit 109 initiates the process to connect the subscriber to the manager. First, the intercom control unit 109 initiates a call to the Manager. When the Manager answers the internal call from the intercom control unit 109, the intercom control unit verifies whether the subscriber is still free to answer the call. If the subscriber is not free, a busy signal is sent to the Manager, and the request is placed back into the queue. This may happen if a subscriber receives a call on the subscriber's “normal” (i.e., telco) service immediately after placing a request for call back. When the subscriber has completed the normal call, the system will again attempt to make a connection as outlined above. If the subscriber line is free, a ring signal is sent to the remote demarcation interface module 104 of the subscriber, from the intercom control unit 109, which, in turn, causes the subscriber's phone to ring.

The remote demarcation module 104 can ring the subscriber's telephone in one of two ways. First, if the RDP power monitor 120 is not producing Loop Voltage, the steering relay 128 allows a Ring Signal Voltage directly to the subscriber, from the intercom control unit 109, resulting in the subscriber's phone ringing. Second, if the RDP power monitor 120 is producing Loop Voltage from the intercom control unit 109, but is currently idle, the presence of the Ring signal directs the microprocessor module 122 to switch the steering relay 128 to the subscriber and monitor the call in progress using the stored energy in the power storage cell 127 for the duration of the call. When the call is terminated, the microprocessor module 122 restores the steering relay 128 back to normal subscriber service, if present.

Turning to FIG. 3, a schematic diagram of a specific exemplary embodiment of the remote demarcation interface module 104 of FIG. 2 is shown. A subscriber's phone 108 is connected to the remote demarcation interface module 104 via a conventional RJ11 telephone jack 108a. A first line of the jack 108a is connected to a first input pin of the first opto-coupler 130, such as a H11AA1, and to a first input of a relay 132 and a second input pin of the first opto-coupler 130 through a 100 ohm resistor R1. The second line of the jack 108a is connected directly to a second input of the relay 132. As discussed previously, the first opto-coupler 130 reads the subscriber hook loop current status, DTMF dialing, and the ring signal, and it transmits this data to the microprocessor 122 for analysis via the status line 125. With this information, the microprocessor 122a determines if the subscriber is on the telephone, if the subscriber has entered a predefined sequence, and what request is associated with the predefined sequence.

A second opto-coupler 134, such as a H11AA1, is connected to the microprocessor 122a and monitors the output voltage of the remote demarcation point 106 via the 5.1 Megohm resistor R9. This output voltage is then transmitted to the microprocessor 122a, via status line 123, providing the microprocessor 122a with the status of the telco service, i.e. if the subscriber service is active. When the subscriber goes off hook, the microprocessor 122a transmits a signal to a synthetic hook switch 136, such as a HT18, which in turn sends a signal to an AC bridge 138, causing power from the intercom control unit 109 to be loaded. The intercom control unit 109 and the AC input side of the AC to DC bridge 138 are also connected to the relay 132. When the relay 132 is switched to a first position, the subscriber's telephone can be used for internal communications, and when the relay 132 is switched to a second position, normal subscriber service is returned.

The AC to DC bridge 138 provides polarity protection to the power circuits. A 0.47 μF capacitor C3, a 470 μF capacitor C4, and a MUE5852 transistor T1 provide a power path that opens during a ring signal so as not to present a ring load to the ring signal causing a misinterpretation of a loaded phone (i.e. the phone has been answered) by the intercom. The 0.47 μF capacitor C3 passes the change in voltage to a 47 kilohm resistor R4 and the base of the MUE5852 transistor T1. This makes the base voltage equal to the emitter voltage, thus pinching off the transistor T1. A IN4004 diode D2 prevents back flushing the charge of capacitor C4 back into transistor T1. This same power path trickle charges, via a 1 kilohm resistor R5 and the diode D2, to the capacitor C4, limited by a 12V Zener diode D3 to 12 Volts. Thus the difference from 24V to 12V limited by the 1 kilohm resistor R5 becomes 12 mA and is below the threshold of the intercom hook-loop current.

A voltage regulator 142, such as an MIC52135V, drops the 12V to 5.3V using a IN5819 diode D4 as an offset. A 5.3V diode D5, such as a IN5819, drops the extra 0.3V to supply 5V to all powered components, and trickle charges the “super cap” C5, rated at 2.2 Farads at 5.5V. When the lines 107 are loaded down below 12 volts during an off-hook condition generated either by the subscriber phone directly or by the function of the synthetic hook switch 136, then the diode D2 prevents any back flush of power into the service loop at the intercom control unit 109. During these brown out conditions (and during the ring signal from the intercom) the super capacitor C5 can provide full power for up to 24 hours. It should be noted that it only has to supply power for a few minutes during an intercom call on the average. In fact, the micro-processor 122a only draws normal power when it “wakes up” at the onset of a subscriber call (dialing period), limited to the first 10 second interval in which a subscriber must dial before the microprocessor 122a returns to a semi-sleep mode and extremely low power draw, until the subscriber recycles by hanging up the phone and lifting it again for a fresh dial tone.

As described above, the power control block 126 is connected to the microprocessor module 122 and is used to trickle charge the power storage cell 127 connected to the power control block 126 using the 24V Loop-Start voltage. In this specific exemplary embodiment of the invention, the internal circuitry of the power control block 126 comprises a 0.1 μF capacitor C1; three 47 kilohm resistors R2, R3, R4; a 5V Zener diode D1; a 0.1 μF capacitor C2; a 0.47 μF capacitor C3; a MUE5852 transistor T1; a 1 kilohm resistor R5; and a IN4004 diode D2.

In the aforementioned specific exemplary embodiment, the internal circuitry of the power storage cell 127 comprises a 5.3V diode D6 (which may be IN5819 diode); a 1 kilohm resistor R6; and the 2.2 F “super” capacitor C5.

Continuing with the description of the specific exemplary embodiment illustrated in FIG. 3, the internal circuitry of the RDP power monitor 120 comprises a 2N2222 transistor T2; a 15 kilohm resistor R7; two 5.1 megohm resistors R8, R9; the second opto-coupler 134; and a 5V DC power supply. The resistor R9 provides a leakage path that lights an LED (not shown) inside the second opto-coupler 134. This conducts a very small current flow inside the second opto-coupler 134 from a 5V DC source 139 to the resistor R7. The transistor T2 amplifies this flow to a logic level from ground via the transistor T2 to the pull up voltage value of the resistor R8, which is also 5V DC.

The steering relay 128 (FIG. 2) is a latch type relay and only requires power to change states. This power comes in the form of a pulse of 10 milliseconds delivered from the microprocessor 122a via the control lines (coil pins 1 and 8 of the relay 128).

The internal circuitry of the subscriber monitor 124 comprises three 47 kilohm resistors R10, R13, R14; a 0.1 μF capacitor C7; the first opto-coupler 130; the 100 ohm resistor R1; a 1 kilohm resistor R11 connected to a 12V DC power supply; a 100 kilohm resistor R12; a 100 pF capacitor C6; and a third 2N2222 transistor T3. The first opto-coupler 130 passes the subscriber current through it and is biased via the resistor R1 to operate at approximately 1V. This dramatically reduces the gain well below the diode knee curve of an LED. The gain of the first opto-coupler 130 is further reduced by bias on the collector and emitter in a feedback loop composed of the resistors R10, R11, R12 and the transistor T3.

An AC signal (DTMF) is allowed to by-pass this DC gain reduction via the capacitor C6. The emitter of the first opto-coupler 130 is biased at about 6V DC with the DTMF riding on top with a typical signal level of 200 mV peak-to-peak. The oil/off nature of this bias is sub-divided to 0V as “off” and 3V DC as “on” (subscriber active) via the resistors R13 and R14. This sub-divided logic level is fed to the microprocessor module 122 as TRUE/FALSE logic called hook status. The DTMF tones are passed through the capacitor C7 for later amplification.

The internal circuitry of the microprocessor module 122 comprises the microprocessor 122a; the synthetic hook switch 136, such as an HT18, with a 270 ohm resistive load 151; an analog amplifier 150, such as an LM4819 to amplify any DTMF signals; a first 20 kilohm resistor R15; a second 20 kilohm resistor R16; a 33 pF band limiter capacitor C9 in parallel with the second 20 kilohm resistor R16; a 1.0 μF anti-pop suppressor capacitor C8; two 47 kilohm resistors R2, R3; two 0.1 μF capacitors C1, C2; and a 5V Zener diode D1.

The microprocessor module 122 is composed of all control signals described above and also includes the microprocessor 122a, such as an Atnels AT Tiny 25, the synthetic hook switch 136, and the low power analog amplifier 150 for boosting the DTMF signal strength back to 2V peak-to-peak. The 270 ohm resistor 151 across the synthetic hook switch 136 acts as an artificial phone load of 270 ohms when the switch 136 is instructed to be “on” by the microprocessor AC control logic. The DTMF signal amplifier comprises the resistors R15 and R16; the band limiter capacitor C9, the analog amplifier 150; the anti-pop suppressor capacitor C8, and the capacitor C1 that drives the artificial 270 ohm load with AC signal (DTMF). Also, one leg of the steering relay logic is used for enabling and disabling the amplifier 150 when its use is not required. Lastly, ring is detected from the intercom control unit 109 via the capacitor C2, which passes the AC signal to a voltage divider made from the resistors R2 and R3 and limited to 5V via the Zener diode D1.

Additionally, it will be appreciated that it is possible to replace substantially all of the discrete components of the remote demarcation interface module described with an application-specific integrated circuit (“ASIC”) microprocessor capable of operating in a very-low-power “standby” or “sleep” mode. Other such modifications will also suggest themselves to those of skill in the art in light of the disclosures contained herein. In the drawings, in addition to the reference numerals, various labels and signals have been shown. It is to be understood that various labels and signals are shown to assist in following the detailed description of the figures and are not intended to limit the scope of the invention.

While the present invention is described above with respect to what is currently considered its preferred embodiments it is to be understood that the invention is not limited to that described above. To the contrary, the invention is intended to cover various modifications and equivalent arrangements within the spirit and scope of the appended claims.

1. An intercom system for use with a remote demarcation point, comprising:
a remote demarcation interface module operatively connected to the remote demarcation point, wherein the remote demarcation interface module selectively connects and disconnects with the remote demarcation point.

2. The intercom system of claim 1, wherein the remote demarcation point supplies a line voltage to the remote demarcation interface unit, and the remote demarcation interface unit monitors the line voltage and selectively disconnects with the remote demarcation point when the line voltage is below a threshold point.

3. The intercom system of claim 1, further comprising an intercom control unit operatively connected to the remote demarcation unit, the intercom control unit including a power source selectively connected to the remote demarcation interface unit.

4. The intercom system of claim 1, wherein the remote demarcation interface module is operatively connected to the intercom control unit by a pair of wires.

5. The intercom system of claim 3, further comprising a subscriber telephone instrument operatively connected to the remote demarcation interface module.

6. The intercom system of claim 5, wherein the remote demarcation interface unit selectively disconnects with the remote demarcation point when the subscriber telephone instrument is off hook.

7. The intercom system of claim 5, wherein the remote demarcation interface unit transmits a signal received from the subscriber telephone interface unit to the intercom control unit.

8. The intercom system of claim 5, wherein the remote demarcation interface unit disconnects with the remote demarcation point when a ring tone is received from the intercom control unit.

9. The intercom system of claim 5, wherein the subscriber telephone instrument is a first subscriber telephone instrument, wherein the intercom control unit is connected to a second subscriber telephone instrument, and wherein, upon receipt of a signal from the first subscriber telephone instrument for a call back from the second subscriber telephone instrument, the intercom control unit stores a signal to initiate a call to the second subscriber telephone instrument and monitors the first subscriber telephone instrument for off hook status to initiate the call to the second subscriber telephone instrument.

10. A control module to connect a subscriber telephone instrument to a remote demarcation point, comprising:
a processor module including processor logic operative to receive and process one or more signals and subscriber monitor logic operative to monitor the subscriber telephone instrument activity and to provide a subscriber control signal to the processor logic; and
a steering relay module operative to selectively connect and disconnect the subscriber telephone instrument to the remote demarcation point upon receipt of a steering control signal from the processor logic, the steering control signal generated by the processor module based upon the subscriber control signal.

11. The control module of claim 10, further comprising power monitor logic configured to monitor power supplied from the remote demarcation point and operative to provide a power control signal to the processor module, wherein the processor module generates a steering control signal to the steering relay module to selectively connect and disconnect the subscriber telephone instrument to the remote demarcation point.

12. The control module of claim 10, wherein the module is connected to an intercom control unit having a power source connected to the steering relay module, and wherein the power source of the intercom control unit is selectively connected to the subscriber telephone instrument by the steering relay module.

13. The control module of claim 12, wherein the control module is connected to the intercom control unit by a pair of wires.

14. The control module of claim 12, further comprising a rechargeable power source charged by the power supply of the intercom control unit.

15. The control module of claim 12, further comprising hook switch logic providing a load to the power supply of the intercom control unit when the subscriber telephone instrument goes off hook.

16. A method to connect a subscriber telephone instrument to a remote demarcation point and an intercom control unit, comprising:
(a) monitoring the subscriber telephone instrument activity and providing a subscriber control signal to a processor logic; and
(b) generating a steering control signal based upon the subscriber control signal to selectively connect and disconnect the subscriber telephone instrument to the remote demarcation point and the intercom control unit.

17. The method of claim 16, further comprising indicating the off hook status of the subscriber telephone instrument to the intercom control unit.

18. The method of claim 16, further comprising detecting a ring tone received from the intercom control unit and transmitting the ring tone to the subscriber telephone instrument.
